(19) United States
(12) Patent Application Publication
(10) Pub. No.: US 2019/0265917 A1
(43) Pub. Date: Aug. 29, 2019

(54) PRINT MANAGER SYSTEM AND METHOD FOR PRINTER SELECTION

(71) Applicants: Kabushiki Kaisha Toshiba, Minato-ku (JP); Toshiba TEC Kabushiki Kaisha, Shinagawa-ku (JP)

(72) Inventor: Michael W. LAWRENCE, Lexington, KY (US)

(21) Appl. No.: 15/903,606

(22) Filed: Feb. 23, 2018

(51) Int. Cl. G06F 3/12

(52) U.S. Cl. CPC G06F 3/126; G06F 3/1232; G06F 3/1294; G06F 3/1296

(57) ABSTRACT

A system and method for monitoring and managing printers includes receiving printer status data associated with a user print job from two or more networked multifunction peripherals. Print job data is compared to the received printer status data. A multifunction peripheral for executing the user's print job is identified in accordance with the comparison. Data identifying the multifunction peripheral includes a subset of the printer status data associated with the identified multifunction peripheral.

### TECHNICAL FIELD

This application relates generally to presenting users with a subset of available printers for printing print jobs. The application relates more particularly to a print manager that monitors local printers and recommends one or more printers to a user based on printer status and the print job to be printed.

### BACKGROUND

Document processing devices are example digital processing devices which include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, devices are frequently shared via a data network. MFPs, while moveable, are generally maintained in a fixed location. Users may send document processing jobs, such as a print request, to one or more networked devices. In a typical shared device setting, one or more workstations are connected via a network. When a user wants to print a document, an electronic copy of that document is sent to a document processing device via the network. The user may select a particular device when several are available. If the user has a large or time-sensitive print job, or print jobs that require special paper or color printouts, the user may not immediately know what other MFP resources are around them.

A user may typically use the same nearby MFP for routine print jobs. However, fault conditions such as paper jams or low toner conditions can occasionally occur. A user may not be aware of the condition until after the user has scheduled a print job to the MFP and the user attempts to retrieve the scheduled print job from the MFP, only to find that either the print job has not be completed or the result does not meet the user's requirements. The user must return to their desk, determine a suitable alternative MFP, and resubmit the print job, which wastes the user's time and negatively impacts the overall user experience. Reprinting the same documents can be wasteful of toner and paper resources and may incur higher printing costs to the company.

### SUMMARY

A system and method for monitoring and managing printers includes receiving printer status data associated with a user print job from two or more networked multifunction peripherals. Print job data is compared to the received printer status data. A multifunction peripheral for executing the user's print job is identified in accordance with the comparison.

In accordance with another aspect of the subject application, the data identifying the multifunction peripheral includes a subset of the printer status data associated with the identified multifunction peripheral.

### BRIEF DESCRIPTION OF THE DRAWINGS

Various embodiments will become better understood with regard to the following description, appended claims and accompanying drawings wherein:

FIG. 1 an example embodiment of a print manager system;

FIG. 2 is an example embodiment of a networked digital device;

FIG. 3 is an example embodiment of a digital data processing device; and

FIG. 4 is a flowchart of an example embodiment of a print manager system for recommending printers for executing user print jobs.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

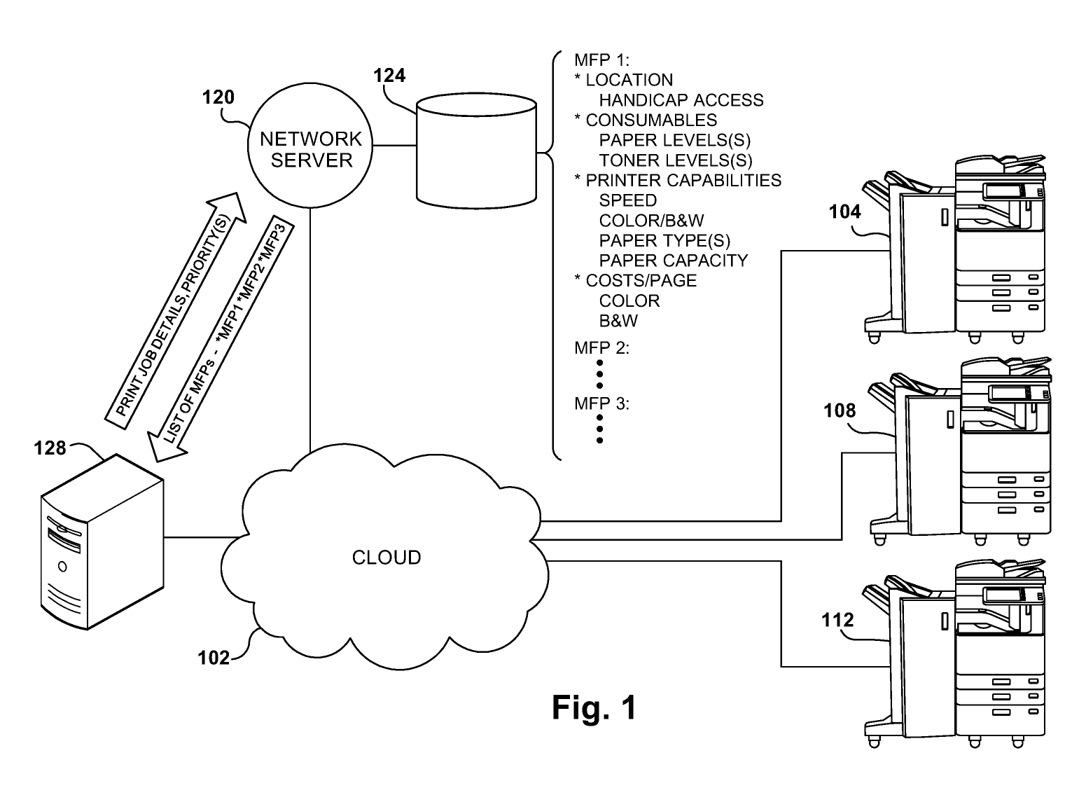

In accordance with the subject application, FIG. 1 illustrates an example embodiment of a print manager system 100 configured to match user print jobs to suitable printers. In the illustrated example, MFPs 104, 108, and 112 are connected to a network 102 suitably comprised of a local area network (LAN), a wide area network (WAN) which may comprise the Internet, or any suitable combination thereof. A network server 120 monitors the MFPs 104, 108, 112, for example by performing polling or walking a management information base (MIB) associated with the MFPs 104, 108, 112. The network server 120 can be a standalone server, a cloud service, or a process executing on a suitable processor which can include a processor associated with an MFP 104, 108, 112, of the user computing device 128 as would be understood in the art.

The network server 120 stores data associated with each of the MFPs 104, 108, and 112 in a data store such as database 124. Example data can include the physical location of the MFP, whether the MFP is handicap accessible, consumable levels such as paper and toner, printer capabilities such as speed or throughput capabilities, color or black-and-white print modes, paper sizes and types, paper capacity, one or two-sided printing, stapling, and so forth, as well as costs associated with different print options.

When a user on a user computing device 128 prints a print job, the user computing device 128 sends data associated with the print job to the network server 120. The user can optionally set, or select, priorities such as handicap accessible, lowest cost, earliest estimated completion time, closest MFP, and so forth. In an embodiment, the priorities can be preset or predefined priorities, for example priorities set by a system administrator or the user. For example, as illustrated at (A), print job details and priority options are transmitted to the network server 120.

The network server 120 receives the print job details and priority options and compares that data to MFP data stored in the database 124 to determine suitable MFPs for executing the print job. The network server 120 then filters, or sorts, the MFPs based on the user priorities and sends a list of suitable MFPs back to the user computing device 128. As illustrated at (B), the list of MFPs can include details about the MFP to assist the user in choosing which MFP to use for the print job. The user can then select the appropriate MFP based on cost, time, convenience or any other suitable metric of their choosing.

For example, if the nearest MFP to the user would not be able to complete the print job, for example due to insufficient paper, the MFP may appear in the list but include an indication that the MFP would require intervention to replenish the paper before the print job could be completed. In another example, if the user attempted to execute a simple 10-page letter-size print job and the user computing device 128 included a default priority setting to use the lowest cost option, then the print job would be sent to the closest MFP to the user with the lowest cost, which might require the user to add paper to the MFP to complete the print job.

In another example, if the user selected a large color print job and the user set the priority to use the most convenient or nearest MFP that could complete the print job without user intervention, the network server 120 would prioritize a more costly MFP over a more economical MFP, but present both options to the user in the list with relevant details so the user can make an informed decision as to which MFP to use. The user can change priorities, for example by selecting cost as a priority, the network server 120 would generate a new list of MFPs accordingly.

In another example, if no MFP exists that matches the print job details, for example if the print job would require the user to load large format paper into the MFP or use the sheet bypass feed to supply the requisite paper for the print job, then a list of MFPs that most closely match the user's preferences and the print job requirements can be generated for the user. Each of the MFPs may be presented with details indicating any necessary user interactions that might need to be undertaken in order for the MFPs to complete the print job.

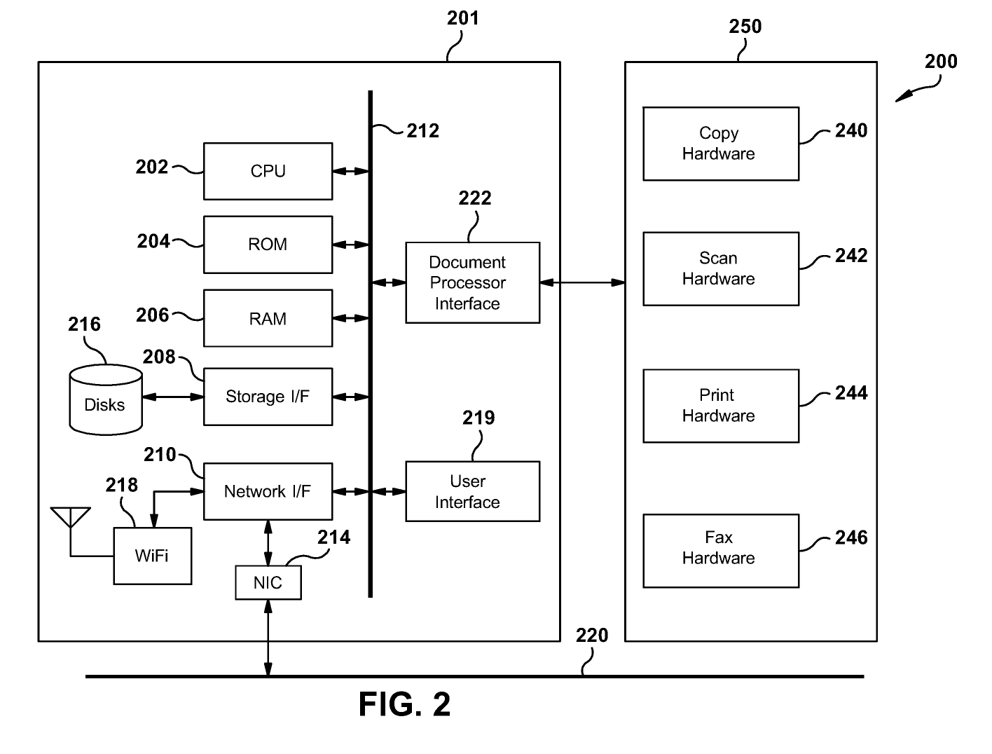

Turning now to FIG. 2 illustrated is an example embodiment of a networked digital device comprised of document rendering system 200 suitably comprised within an MFP, such as with MFPs 104, 108, and 112 of FIG. 1. It will be appreciated that an MFP includes an intelligent controller 201 which is itself a networked computing system. Thus, an MFP can itself function as a print manager system with the capabilities described herein. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with one or more sensors which provide data relative to a state of the device or associated surroundings, such as device temperature, ambient temperature, humidity, device movement and the like. Hardware monitors suitably provide device event data, working in concert with suitable monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

Controller 201 is suitably provided with an embedded web server system for device configuration and administration. A suitable web interface is comprised of TOPACCESS Controller (sometimes referred to in the subject illustrations as “TA”), available from Toshiba TEC Corporation.

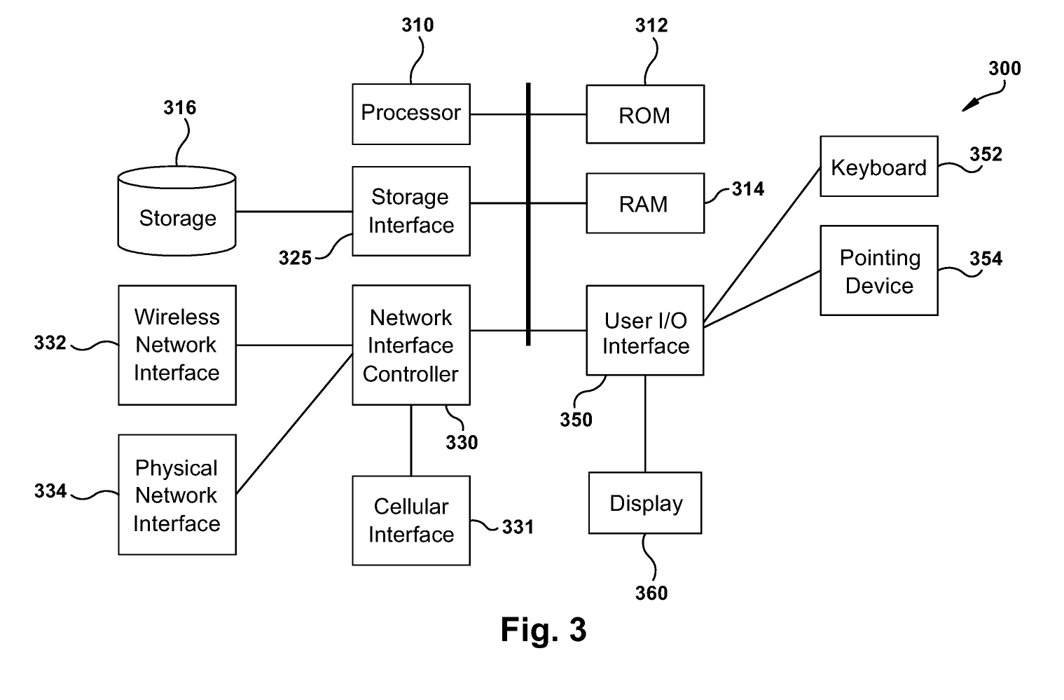

Turning now to FIG. 3, illustrated is an example embodiment of a digital data processing device 300, suitably comprising devices such as the user computing device 128, the network server 120, or the database 124 of FIG. 1 as would be understood in the art. Components of the data processing device 300 suitably include one or more processors, illustrated by processor 310, memory, suitably comprised of read-only memory 312 and random access memory 314, and bulk or other non-volatile storage 316, suitable connected via a storage interface 325. A network interface controller 330 suitably provides a gateway for data communication with other devices via wireless network interface 332 and physical network interface 334, as well as a cellular interface 231 such as when the digital device is a cell phone or tablet computer. A user input/output interface 350 suitably provides a gateway to devices such as keyboard 352, pointing device 354, and display 260, suitably comprised of a touch-screen display. It will be understood that the computational platform to realize the system as detailed further below is suitably implemented on any or all of devices as described above.

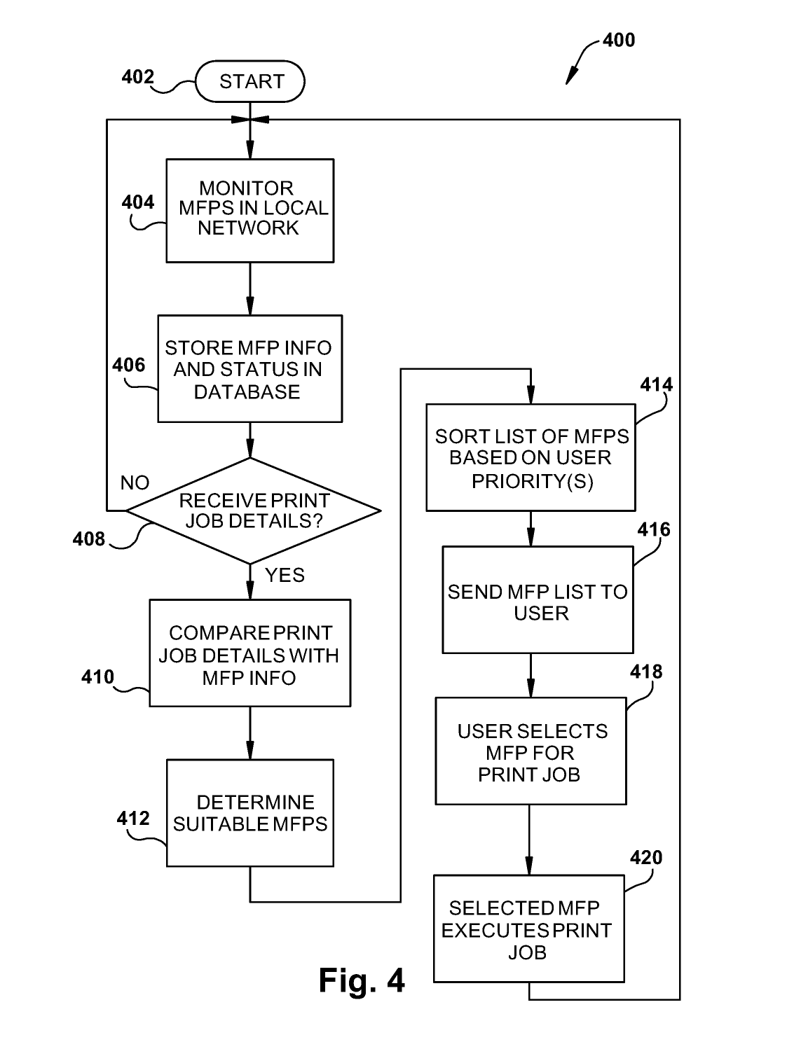

Referring next to FIG. 4, illustrated is a flowchart 400 of a print manager system for matching user print jobs with available MFPs. The process commences at block 402, and print manager system monitors one or more local MFPs at block 404. Monitoring of the MFPs can be accomplished by polling a MIB associated with each MFP, by receiving status messages from MFPs, or by an administrator entering configuration information about one or more of the MFPs. At block 406, the status and configuration information about each of the local MFPs is suitable stored in a database. Until the print manager system receives print job details from a user computing device at decision block 408, the print manager system continues to loop back to block 404 to monitor the MFPs.

Once the print manager system receives print job details from a user computing device at decision block 408, the print manager system compares the received print job details at block 410 with information about the MFPs that is stored in the database. The print manager system determines suitable MFPs at block 412, and the print manager system sorts and filters the list of suitable MFPs at block 414 based on the user priorities such as cost, convenience, and so forth as described above.

At block 416, the filtered, sorted list of MFPs is sent to the user. In an embodiment, only the MFP that best fits the criteria is recommended to the user. In an embodiment, the list includes a subset of MFPs, for example a list of the top three MFPs that match the user criteria and print job requirements. In an embodiment, the list includes all matching MFPs. In an embodiment, the list includes the MFP that is the best match, along with one or more other MFPs that satisfy other criteria, such as lower cost options for performing the same print job, or closer MFPs that may take slightly longer to print the print job but which are more convenient to the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a network interface configured to
receive printer status data from a plurality of multifunction peripherals, and
receive, from a device user, print job data associated with a print job from the device user's computing device; and
a processor and associated memory,
the memory configured to
store the printer status data,
store user preference data comprising preselected custom printing device preferences specified by each of a plurality of users including the device user,
the processor configured to
compare the print job data and the device user's user preference data to printer status data associated with each of the plurality of multifunction peripherals,
determine a subset of the multifunction peripherals, based on the compare operation, for executing the user print job, and
send data identifying each multifunction peripheral of the subset of multifunction peripherals along with its associated printer status data to the user computing device via the network interface.

2. The system of claim 1, wherein the data identifying the at least one multifunction peripheral includes at least a subset of the printer status data associated with the at least one multifunction peripheral.

3. The system of claim 1, wherein the processor is further configured to:
generate a list of multifunction peripherals capable of executing the user print job based at least in part on the print job data, and
send the list to the user computing device via the network interface,
wherein the list includes at least a subset of printer status data associated with one of the multifunction peripherals.

4. The system of claim 3, wherein the network interface is further configured to receive a priority parameter, and
wherein the processor is further configured to sort the list of multifunction peripherals, based at least in part on the priority parameter, prior to sending the list to the user computing device.

5. The system of claim 4, wherein the processor is further configured to filter the list of multifunction peripherals, based at least in part on the priority parameter, prior to sending the list to the user computing device.

6. The system of claim 4, wherein the priority parameter is
a proximity of the user computing device to a multifunction peripheral,
a handicap accessible requirement,
a lowest cost preference,
an earliest estimated completion time preference, or
a preference to not require user intervention on a multifunction peripheral to complete the user print job.

7. The system of claim 1, wherein the printer status data for each multifunctional peripheral includes one or more of
a physical location of the multifunctional peripheral,
data indicative of whether the multifunctional peripheral is handicap accessible,
one or more consumable levels for paper or toner,
one or more printer capabilities associated with paper sizes, paper types, paper capacity, one or two-sided printing, stapling, color or black-and-white print modes, or throughput capacity, or
a cost associated with one or more print modes.

8. The system of claim 1, wherein the print job data includes one or more of
a number of pages in the user print job,
a paper size for the user print job,
a paper type for the user print job,
an indication of one or two-sided printing,
an indication to staple the user print job upon completion, or
an indication to use a color or a black-and-white print mode.

9. The system of claim 1, further comprising:
a multifunction peripheral having an intelligent controller that includes the network interface, the processor, and the associated memory.

10. A method comprising:
receiving, by a networked computing system, printer status data from each of a plurality of monitored multifunction peripherals;
receiving, from a device user's computing device, print job data associated with a user print job associated with the device user;
retrieving, from a memory, user preference data comprising custom device preferences preselected by the device user;
comparing, by the networked computing system, the print job data and the user preference with the printer status data;
determining, by the networked computing system and based on the comparing operation, a subset of the monitored multifunction peripherals for executing the user print job; and
sending, to the user computing device, data identifying each multifunction peripheral of the subset of multifunction peripherals for executing the user print job and its associated printer status data.

11. The method of claim 10, furthering comprising:
polling, by the networked computing system, each of the monitored multifunction peripherals for printer status data.

12. The method of claim 10, furthering comprising:
generating, by the networked computing system, a list of monitored multifunction peripherals capable of executing the print job based at least in part on the print job data, and
sending, by the networked computing system, the list of monitored multifunction peripherals to the user computing device,
wherein the list includes at least a subset of the printer status data for at least one of the monitored multifunction peripherals in the list.

13. The method of claim 12, furthering comprising:
receiving, by the networked computing system, a priority parameter for one or more of prioritizing or filtering monitored multifunction peripherals; and
prioritizing, by the networked computing system and based at least in part on the priority parameter, the list of monitored multifunction peripherals prior to sending to the user computing device.

14. The method of claim 13, furthering comprising:
filtering, by the networked computing system and based at least in part on the priority parameter, the list of monitored multifunction peripherals prior to sending to the user computing device.

15. The method of claim 14, wherein the priority parameter is
a proximity of the user computing device to a multifunction peripheral,
a handicap accessible requirement,
a lowest cost preference,
an earliest estimated completion time preference, or
a preference to not require user intervention on a multifunction peripheral to complete the user print job.

16. The method of claim 10, wherein the printer status data for each multifunctional peripheral includes one or more of
a physical location of the multifunctional peripheral,
data indicative of whether the multifunctional peripheral is handicap accessible,
one or more consumable levels for paper or toner,
one or more printer capabilities associated with paper sizes, paper types, paper capacity, one or two-sided printing, stapling, color or black-and-white print modes, or throughput capacity, or
a cost associated with one or more print modes.

17. The method of claim 10, wherein the print job data includes one or more of
a number of pages in the user print job,
a paper size for the user print job,
a paper type for the user print job,
an indication of one or two-sided printing,
an indication to staple the user print job upon completion, or
an indication to use a color or a black-and-white print mode.

18. The method of claim 10, wherein the networked computing system is a multifunction peripheral.

19. A multifunction peripheral comprising:
a network interface configured to
receive printer status data from each of a plurality of other multifunction peripherals, and
receive, from a device user, print job data associated with user print job associated with the device user from a user computing device; and
an intelligent controller including a processor and a memory
the memory configured to store
printer status data, and
user preference data comprising preselected custom printing device preferences specified be each of a plurality of users including the device user,
the processor configured to
monitor the multifunction peripheral,
generate printer status data for the multifunction peripheral,
store the printer status data for the multifunction peripheral in the memory,
compare the print job data and the device user's user preference data to printer status data associated with each monitored multifunction peripheral including the multifunction peripheral,
determine a subset of multifunction peripherals, based on the compare operation, for executing the user print job,
send data identifying each multifunction peripheral in the subset of multifunction peripherals and at least a subset of associated printer status data to the user computing device via the network interface, and
receiving, from the device user, a selected multifunction peripheral selected from the subset of multifunction peripherals; and
a document processing engine associated with the selected multifunction peripheral configured to be operated by the intelligent controller to print the user print job.

20. The multifunction peripheral of claim 19, wherein the network interface is further configured to receive a priority parameter, and
wherein the processor is further configured to sort and filter the list of multifunction peripherals based at least in part on the priority parameter.
